(19) United States
(12) Patent Application Publication
(10) Pub. No.: US 2026/0030632 A1
(43) Pub. Date: Jan. 29, 2026

(54) COMPUTER-BASED SYSTEMS CONFIGURED TO AUTOMATICALLY AUTHENTICATE AN EXECUTION OF AN ACTION BASED ON LOCATION AND METHODS OF USE THEREOF

(71) Applicant: Capital One Services, LLC, McLean, VA (US)

(72) Inventors: Armando Martinez Stone, Arlington, VA (US); Samuel Rapowitz, Roswell, GA (US); Bryant Yee, Silver Spring, MD (US)

(21) Appl. No.: 18/781,589

(22) Filed: Jul. 23, 2024

(51) Int. Cl. G06Q 20/40

(52) U.S. Cl. CPC G06Q 20/4015

(57) ABSTRACT

In some embodiments, the present disclosure provides an exemplary method that may include steps of receiving a permission from at least one user of a plurality of users to monitor at least one location associated with a device, utilizing a machine learning algorithm to automatically authenticate at least one action associated with the device based on at least one data beacon generating a primed signal; transmitting a plurality of data from the device to an external data source associated with the at least one action within a predetermined period of time based on the location of the device and the primed signal; and dynamically updating a storage module associated with the device with metadata based on a transmission of the plurality of data associated with the at least one action.

### FIELD OF TECHNOLOGY

The present disclosure generally relates to computer-based systems configured to automatically authenticate an execution of an action based on location and methods of use thereof.

### BACKGROUND OF TECHNOLOGY

Typically, spam may be directed to large numbers of users for the purposes of advertising, phishing, and/or spreading malware. Usually, spam may include all forms of unwanted communications including, but not limited to unsolicited calls or messages, caller identification spoofing, and/or robocalls. Typically, a goal or purpose of a spam call may be to sell some good(s) that might be unsolicited or unwanted.

### SUMMARY OF DESCRIBED SUBJECT MATTER

In some embodiments, the present disclosure provides an exemplary technically improved computer-based method that may include at least the following steps: receiving a permission from a user of a plurality of users to monitor a location associated with a computing device, where the location associated with the computing device is identified utilizing a plurality of geo-fencing sensors to triangulate the location associated with the computing device; utilizing a machine learning algorithm to automatically authenticate an action associated with the computing device based on a data beacon of a plurality of data beacons generating a primed signal; transmitting a plurality of data from the computing device to an external data source associated with the action within a predetermined period of time based on the location of the device and the primed signal; and dynamically updating a storage module associated with the computing device with metadata based on a transmission of the plurality of data associated with the action.

In some embodiments, the present disclosure provides an exemplary technically improved computer-based systems that may include: a non-transient computer memory, storing software instructions; at least one processor of a first computing device associated with a user; where, when the processor executes the software instructions, the first computing device is programmed to: receive a permission from a user of a plurality of users to monitor a location associated with a computing device, where the location associated with the computing device is identified utilizing a plurality of geo-fencing sensors to triangulate the location associated with the computing device; utilize a machine learning algorithm to automatically authenticate an action associated with the computing device based on a data beacon of a plurality of data beacons generating a primed signal; transmit a plurality of data from the computing device to an external data source associated with the action within a predetermined period of time based on the location of the device and the primed signal; and dynamically update a storage module associated with the computing device with metadata based on a transmission of the plurality of data associated with the action.

### BRIEF DESCRIPTION OF DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 depicts a block diagram of an exemplary computer-based system and platform for automatically authenticating an action associated with the device based on a data beacon generating a primed signal, in accordance with one or more embodiments of the present disclosure.

FIG. 2 is a block diagram illustrating operational steps for automatically authenticating an action associated with the device based on at least one data beacon generating a primed signal, in accordance with one or more embodiments of the present disclosure.

FIG. 3 is a block diagram illustrating operational steps for geo-locating a computing device in real-time, in accordance with one or more embodiments of the present disclosure.

FIG. 4 depicts a block diagram of an exemplary computer-based system/platform in accordance with one or more embodiments of the present disclosure.

FIG. 5 depicts a block diagram of another exemplary computer-based system/platform in accordance with one or more embodiments of the present disclosure.

FIGS. 6 and 7 are block diagrams illustrating implementations of cloud computing architecture/aspects with respect to which the disclosed technology may be specifically configured to operate, in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a creator interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, daily, several days, weekly, monthly, etc.

As used herein, the term “runtime” corresponds to any behavior that is dynamically determined during an execution of a software application or at least a portion of a software application.

At least some embodiments of the present disclosure provide technological solution(s) to at least one technological computer-centered problem associated with allowing an authorized user access to a predetermined amount of funds of an account associated with a digital card. Typically, the problem arises when the authorized user is given access to a digital card and proceeds to make one or more purchases that exceed a predetermined limit associated with the account. In other instances, the problem arises when a non-authorized user seeks permission to use the digital card for a predetermined period of time and/or at a predetermined location. These technological computer-centered problems may decrease customer experience, allow for fraudulent transactions occurring on the digital card, and allow overdraft and accompanying overdraft fees that affect the account of the user. As detailed in at least some embodiments herein, at least one technological computer-centered solution addressing the technological computer-centered problem may be to automatically authenticate at least one action associated with the digital card based on a locational data beacon transmitting a priming signal. In some embodiments, the present disclosure details that one practical solution may be to update a storage module of the digital card with metadata associated with the at least one action. For example, the digital card may automatically authenticate a transaction for a coffee in response to the data beacon located near the coffee shop alerts the user that the data beacon generated a primed signal based on the digital card crossing a geo-fencing threshold. In some embodiments, the present disclosure may transmit a plurality of data from the digital card to an external data source (e.g., a server associated with a banking institution) associated with action within a predetermined period of time based on the location of the digital card and the primed signal. In some embodiments, the present disclosure may dynamically update a storage module associated with the device with metadata based on a transmission of the plurality of data associated with the action.

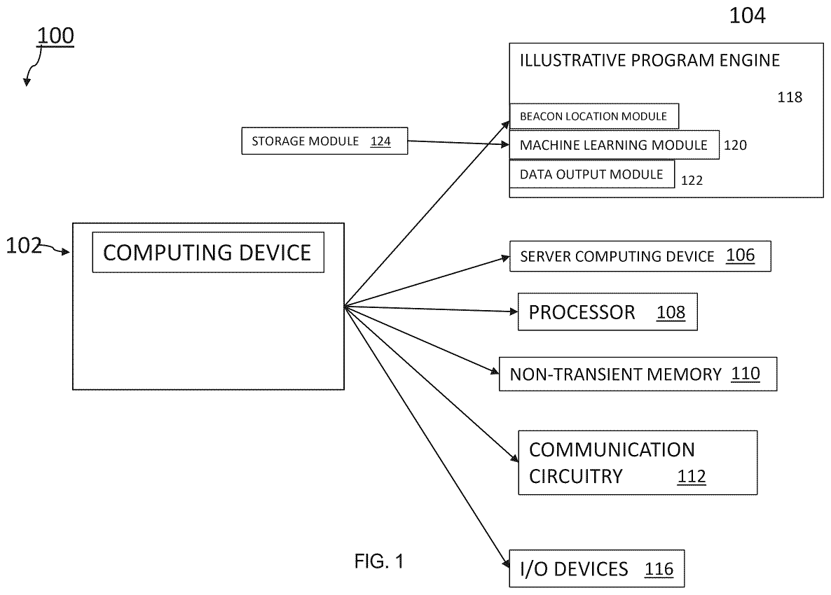

FIG. 1 depicts a block diagram of an exemplary computer-based system and platform for automatically authenticating an action associated with a device based on a data beacon generating a primed signal, in accordance with one or more embodiments of the present disclosure.

In some embodiments, an illustrative computing system 100 of the present disclosure may include at least one computing device 102 associated with at least one user and an illustrative program engine 104. In some embodiments, the illustrative program engine 104 may be stored on the computing device 102. In some embodiments, the illustrative program engine 104 may be executed on the computing device 102 or a server computing device 106, a processor 108, a non-transient memory 110, a communication circuitry 112 for communicating over a communication network 114 (not shown), and input and/or output (I/O) devices 116 such as a keyboard, mouse, a touchscreen, and/or a display, for example. In some embodiments, the computing device 102 may refer to at least one communicative computing device of a plurality of communicative computing devices. In certain embodiments, the server computing device 106 may be an external data source that is considered hardware. In some embodiments, the server computing device 106 may consist of a plurality of software engines to perform actions. In some embodiments, the computing device 102 may be considered the server computing device 106. For example, the computing device 102 is a digital credit card, a smart credit card, a smart phone, and/or a laptop. In some instances, the computing device 102 may be the at least one smart credit card with an ability to execute a plurality of actions; communicate with a plurality of data beacons and update a storage module with metadata based on an execution of an action. In certain embodiments, the smart card can include the server computing device 106 to utilize the software engines to perform the plurality of actions.

In some embodiments, the illustrative program engine 104 may be configured to instruct the processor 108 to execute one or more software modules such as, without limitation, an exemplary beacon locator module 118, a machine learning module 120, and/or a data output module 122.

In some embodiments, an exemplary beacon locator module 118 of the present disclosure may utilize at least one trained machine learning module 120, described herein, to automatically authenticate an action associated with the computing device 102 based on a data beacon generating a primed signal. The action may refer to a transfer of data from an account associated with the computing device 102 to an external data source. For example, the action may refer to a digital transaction of funds. In some embodiments, the beacon locator module 118 may receive a permission from a user of a plurality of users to monitor a location associated with the computing device 102. The permission of the user may be received via a user interface that communicates with the computing device 102. In some embodiments, the user interface may refer to an application capable of receiving and transmitting data to the computing device 102. In certain embodiments, the computing device 102 may refer to a smart card capable of performing data transfers from a data source. In certain embodiments, the smart card may be capable of performing data transfers between anywhere from two data sources to twenty data sources. In certain embodiments, the smart card may be capable of performing data transfers between an unlimited number of data sources. In some embodiments, the permission may allow the movements and activity associated with the smart card to be continually monitored. In certain embodiments, the location associated with the computing device 102 may be identified via a utilization of a plurality of geo-fencing sensors. These geo-fencing sensors would be placed near one or more particular established merchants or predetermined routes of travel associated with the computing device 102. In certain instances, the geo-fencing sensors may be placed to surround the particular established merchant or the predetermined routes of travel, where the sensors would be placed along the route. In some embodiments, the plurality of geo-fencing sensors can triangulate a location associated with the computing device 102 in real-time with an accuracy within a range of certainty ranging from a minimum of less than one foot and a maximum of ten feet. In some embodiments, the range of certainty associated with the plurality of geo-fencing sensors may extend to 100 feet. In certain embodiments, the range of certainty associated with the plurality of geo-fencing sensors may extend a mile. In certain embodiments, the beacon locator module 118 may utilize the plurality of geo-fencing sensors to continually locate the location of the computing device 102 in real-time for an extended period of time, as the computing device 102 remains within the triangulated area. In some embodiments, the beacon locator module 118 may utilize the machine learning module 120 to automatically authenticate an action associated with the computing device 102 based on a data beacon generating a primed signal. In some embodiments, the primed signal may refer to a signal associated with a first data beacon of a plurality of data beacons within the triangulated area, where the priming of the signal occurs in response to an execution of at least one permissible action. In some embodiments, the authentication verifies the identity of the user of the computing device 102 and/or the permission of the verified user to allow the action to occur in an absence of a presence of the verified user. In some embodiments, the beacon locator module 118 may transmit a plurality of data from the computing device 102 to an external data source associated with the authenticated action within the predetermined period of time based on the location of the computing device 102 and the generated primed signal. In some embodiments, the beacon locator module 118 may dynamically update a storage module 124 associated with the computing device 102 with metadata based on a transmission of data in response to the execution of the action. In some embodiments, the beacon locator module 118 may utilize the machine learning module 120 to predict a plurality of trends associated with a plurality of dynamic updates to the storage module 124 over the predetermined period of time. In certain embodiments, the plurality of trends may refer to a plurality of identifiable features associated with the action, such as time of transfer, type of transfer, a database of permissible users, and/or modifications to each feature. In some embodiments, the beacon locator module 118 may automatically terminate the execution of action associated with the computing device 102 in response to an attempt of an action outside of the permissible geo-location area and/or the permissible predetermined period of time.

In some embodiments, the present disclosure describes systems for utilizing the machine learning module 120 that may automatically authenticate an action associated with the computing device 102 based on a data beacon generating a primed signal. In some embodiments, the machine learning module 120 may receive a permission from a user of a plurality of users to monitor a location associated with the computing device 102. In certain embodiments, the location may refer to a permissible triangulated area, where the user allows for execution of actions in an absence of the presence of the user. In some embodiments, the machine learning module 120 may utilize the plurality of geo-fencing sensors to continually locate the location of the computing device 102 in real-time for an extended period of time, as the computing device 102 remains within the permissible triangulated area. In some embodiments, the machine learning module 120 may automatically authenticate an action associated with the computing device 102 based on a data beacon generating a primed signal in response to locating the computing device 102 within the permissible triangulated area. In some embodiments, the machine learning module 120 may transmit a plurality of data from the computing device 102 to an external data source associated with the authenticated action within the predetermined period of time based on the location of the computing device 102 and the generated primed signal. In certain embodiments, an example of the authenticated action may refer to a purchase, a transaction of goods, a transaction of service, and a sale to the particular established merchant. In some embodiments, the machine learning module 120 may dynamically update the storage module 124 associated with the computing device 102 with metadata based on a transmission of data in response to the execution of the action. In certain embodiments, the metadata may refer to a plurality of identifiable features associated with the execution of a plurality of actions of the predetermined period of time. In some embodiments, the machine learning module 120 may predict a plurality of trends associated with a plurality of dynamic updates to the storage module 124 over the predetermined period of time. In certain embodiments, the plurality of trends may refer to a plurality of identifiable features associated with the action, such as time of transfer, type of transfer, a database of permissible users, and/or modifications to each feature. In some embodiments, the machine learning module 120 may automatically terminate the execution of action associated with the computing device 102 in response to an attempt of an action outside of the permissible geo-location area and/or the permissible predetermined period of time.

In some embodiments, the data output module 122 may output the execution of the action associated with the computing device 102 based on the data beacon generating the primed signal. The output of the execution of the action may refer to performing the action and/or generating instructions to execute the action that may be transmittible to external data sources. In some embodiments, the data output module 122 may output a permission from a user of a plurality of users to monitor a location associated with the computing device 102. In some embodiments, the data output module 122 may output a result of a utilization of the plurality of geo-fencing sensors to continually locate the location of the computing device 102 in real-time for an extended period of time, as the computing device 102 remains within the permissible triangulated area. In some embodiments, the data output module 122 may output a result of a utilization of the machine learning module 120 to automatically authenticate an action associated with the computing device 102 based on a data beacon generating a primed signal in response to locating the computing device 102 within the permissible triangulated area. In some embodiments, the data output module 122 may output a plurality of instructions to transmit a plurality of data from the computing device 102 to an external data source associated with the authenticated action within the predetermined period of time based on the location of the computing device 102 and the generated primed signal. In some embodiments, the data output module 122 may output a dynamically update to a storage module 124 associated with the computing device 102 with metadata based on a transmission of data in response to the execution of the action. In some embodiments, the data output module 122 may output a prediction of a plurality of trends associated with a plurality of dynamic updates to the storage module 124 over the predetermined period of time. In some embodiments, the data output module 122 may output a plurality of instructions to automatically terminate the execution of the action in response to an attempt of an action outside of the permissible geo-location area and/or the permissible predetermined period of time.

In some embodiments, the illustrative program engine 104 may receive a permission from a user of a plurality of users to monitor a location associated with the computing device 102. In certain embodiments, the computing device 102 may refer to a smart card capable of performing data transfers between two data sources. In some embodiments, the permission may allow the movements and activity associated with the smart card to be continually monitored. In certain embodiments, the location associated with the computing device 102 may be identified via a utilization of a plurality of geo-fencing sensors. In some embodiments, the plurality of geo-fencing sensors can triangulate a location associated with the computing device 102 in real-time with an accuracy within a range of certainty ranging from a minimum of less than one foot and a maximum of ten feet. In some embodiments, the illustrative program engine 104 may utilize the machine learning module 120 to automatically authenticate an action associated with the computing device 102 based on a data beacon generating a primed signal. In some embodiments, the illustrative program engine 104 may transmit a plurality of data from the computing device 102 to an external data source associated with the authenticated action within the predetermined period of time based on the location of the computing device 102 and the generated primed signal. In some embodiments, the illustrative program engine 104 may dynamically update a storage module 124 associated with the computing device 102 with metadata based on a transmission of data in response to the execution of the action. In some embodiments, the illustrative program engine 104 may utilize the machine learning module 120 to predict a plurality of trends associated with a plurality of dynamic updates to the storage module 124 over the predetermined period of time. In certain embodiments, the plurality of trends may refer to a plurality of identifiable features associated with the action, such as time of transfer, type of transfer, a database of permissible users, and/or modifications to each feature. In some embodiments, the illustrative program engine 104 may automatically terminate the execution of action associated with the computing device 102 in response to an attempt of an action outside of the permissible geo-location area and/or the permissible predetermined period of time.

In some embodiments, the non-transient computer memory 110 may store an output of the execution of the action associated with the computing device 102 based on the data beacon generating the primed signal. In some embodiments, the output of the execution of the action may refer to performing the action and/or generating instructions to execute the action that may be transmittible to external data sources. In some embodiments, the non-transient computer memory 110 may store a permission from a user of a plurality of users to monitor a location associated with the computing device 102. In some embodiments, the non-transient computer memory 110 may store a result of a utilization the plurality of geo-fencing sensors to continually locate the location of the computing device 102 in real-time for an extended period of time, as the computing device 102 remains within the permissible triangulated area. In some embodiments, the non-transient computer memory 110 may store a result of a utilization of the machine learning module 120 to automatically authenticate an action associated with the computing device 102 based on a data beacon generating a primed signal in response to locating the computing device 102 within the permissible triangulated area. In some embodiments, the non-transient computer memory 110 may store a plurality of instructions to transmit a plurality of data from the computing device 102 to an external data source associated with the authenticated action within the predetermined period of time based on the location of the computing device 102 and the generated primed signal. In some embodiments, the non-transient computer memory 110 may store a dynamically update to a storage module 124 associated with the computing device 102 with metadata based on a transmission of data in response to the execution of the action. In some embodiments, the non-transient computer memory 110 may store a prediction of a plurality of trends associated with a plurality of dynamic updates to the storage module 124 over the predetermined period of time. In some embodiments, the non-transient computer memory 110 may store a plurality of instructions to automatically terminate the execution of the action in response to an attempt of an action outside of the permissible geo-location area and/or the permissible predetermined period of time.

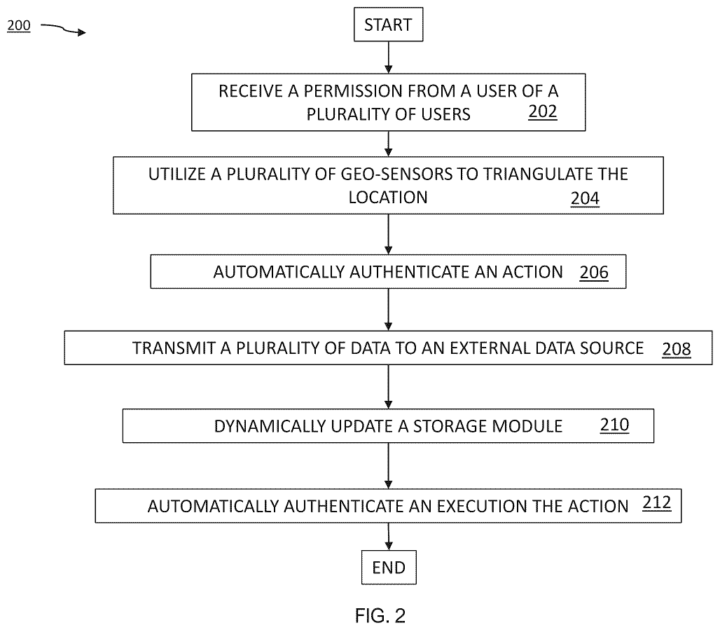

FIG. 2 is a flowchart 200 illustrating operational steps for automatically authenticating an action associated with the device based on at least one data beacon generating a primed signal, in accordance with one or more embodiments of the present disclosure.

In step 202, the illustrative program engine 104 within the computing device 102 may receive a permission from a user of a plurality of users. In some embodiments, the illustrative program engine 104 may receive the permission from the user to monitor a location associated with the computing device 102. In certain embodiments, the computing device 102 may refer to a smart card capable of performing data transfers between two data sources. In some embodiments, the permission may allow the movements and activity associated with the smart card to be continually monitored. In certain embodiments, the location associated with the computing device 102 may be identified via a utilization of a plurality of geo-fencing sensors. In some embodiments, the plurality of geo-fencing sensors can triangulate a location associated with the computing device 102 in real-time with an accuracy within a range of certainty ranging from a minimum of less than one foot and a maximum of ten feet. In some embodiments, the illustrative program engine 104 may utilize the plurality of geo-fencing sensors to continually locate the location of the computing device 102 in real-time for an extended period of time, as the computing device 102 remains within the triangulated area. In certain embodiments, the beacon locator module 118 may receive the permission from the user to monitor a location associated with the computing device 102.

In step 204, the illustrative program engine 104 may utilize a plurality of geo-fencing sensors to triangulate the location. In some embodiments, the illustrative program engine 104 may utilize the plurality of geo-fencing sensors to triangulate the location associated with the computing device 102. In some embodiments, the illustrative program engine 104 may utilize the plurality of geo-fencing sensors to triangulate the location associated with the computing device 102 in response to receiving the permission from the user to monitor the location. In some embodiments, the geo-fencing sensors would be placed near one or more particular established merchants or predetermined routes of travel associated with the computing device 102. In certain instances, the geo-fencing sensors may be placed to surround the particular established merchant or the predetermined routes of travel, where the sensors would be placed along the route. In some embodiments, the plurality of geo-fencing sensors can triangulate a location associated with the computing device 102 in real-time with an accuracy within a range of certainty ranging from a minimum of less than one foot and a maximum of ten feet. In some embodiments, the range of certainty associated with the plurality of geo-fencing sensors may extend to 100 feet. In certain embodiments, the range of certainty associated with the plurality of geo-fencing sensors may extend a mile. In some embodiments, the beacon locator module 118 may utilize the plurality of geo-fencing sensors to triangulate the location associated with the computing device 102.

In step 206, the illustrative program engine 104 may automatically authenticate an action. In some embodiments, the illustrative program engine 104 may utilize the machine learning module 120 to automatically authenticate the action. In some embodiments, the illustrative program engine 104 may automatically authenticate the action based on a data beacon of a plurality of data beacons generating a primed signal. In some embodiments, the primed signal may refer to a signal associated with a first data beacon of a plurality of data beacons within the triangulated area, where the priming of the signal occurs in response to an execution of a permissible action. In some embodiments, the authentication verifies the identity of the user of the computing device 102 and/or the permission of the verified user to allow the action to occur in an absence of a presence of the verified user. In certain embodiments, the beacon locator module 118 may utilize the machine learning module 120 to automatically authenticate the action associated with the computing device 102 based on the data beacon of the plurality of data beacons generating the primed signal.

In step 208, the illustrative program engine 104 may transmit a plurality of data to an external data source. In some embodiments, the illustrative program engine 104 may transmit the plurality of data from the computing device 102 to the external data source associated with the authenticated action within the predetermined period of time in response to authenticating the action. The transmission of the plurality of data may refer to a permissible transfer of funds, a transaction, and/or a digital exchange that occurs within the permissible triangulation area of the computing device 102 and the generated primed signal associated with the data beacon of the plurality of data beacons. In some embodiments, the external data source may refer to a server computing device 106 associated with a banking institution. In certain embodiments, the beacon locator module 118 may transmit the plurality of data from the computing device 102 to the external data source associated with the authenticated action within the predetermined period of time in response to authenticating the action.

In step 210, the illustrative program engine 104 may dynamically update a storage module 124. In some embodiments, the illustrative program engine 104 may dynamically update the storage module 124 associated with the computing device 102 with metadata based on a transmission of the data in response to the execution of the action. In certain embodiments, the metadata may refer to a plurality of identifiable features associated with the execution of a plurality of actions of the predetermined period of time. In some embodiments, the beacon locator module 118 may utilize the machine learning module 120 to predict a plurality of trends associated with a plurality of dynamic updates to the storage module 124 over the predetermined period of time. In certain embodiments, the plurality of trends may refer to a plurality of identifiable features associated with the action, such as time of transfer, type of transfer, a database of permissible users, and/or modifications to each feature. In some embodiments, the beacon locator module 118 may automatically terminate the execution of action associated with the computing device 102 in response to an attempt of an action outside of the permissible geo-location area and/or the permissible predetermined period of time.

In step 212, the illustrative program engine 104 may automatically authenticate an execution of the action. In some embodiments, the illustrative program engine 104 may automatically authenticate the execution of the action associated with the computing device 102. In some embodiments, the illustrative program engine 104 may automatically authenticate the execution of the action associated with the computing device 102 in response to an attempt of an action within the permissible geo-location area. In certain embodiments, the attempt of the action within the permissible geo-location based on the location of the computing device 102 may refer to a purchase, a transaction of goods, a transaction of service, and an attempt to sell a good to the particular established merchant within the permissible geo-location. In certain embodiments, the illustrative program engine 104 may automatically authenticate the execution of the action associated with the computing device 102 in response to an attempt of an action within the predetermined period of time. The automatic authentication may refer to an allowance of an action without the need for further permission from the user. In some embodiments, the beacon locator module 118 may automatically authenticate the execution of the action associated with the computing device 102.

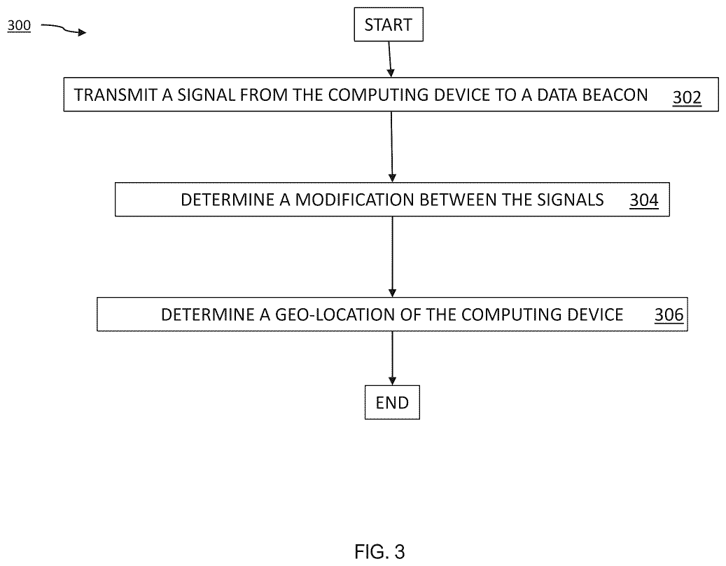

FIG. 3 is a flowchart 300 illustrating operational steps for geo-locating a computing device in real-time, in accordance with one or more embodiments of the present disclosure.

In step 302, the illustrative program engine 104 within the computing device 102 may transmit a signal from the computing device 102 to a data beacon. In some embodiments, the illustrative program engine 104 may transmit a digital signal from the computing device 102 to a first data beacon of the plurality of beacons via a communication network 114. In certain embodiments, the illustrative program engine 104 may transmit an electronic digital signal from the computing device 102 to the first data beacon. In certain embodiments, the illustrative program engine 104 may transmit a light digital signal from the computing device 102 to the first data beacon. In some embodiments, the beacon locator module 118 may transmit a digital signal from the computing device 102 to a first data beacon of the plurality of beacons via the communication circuitry 112.

In step 304, the illustrative program engine 104 may determine a modification between the signals. In some embodiments, the illustrative program engine 104 may determine the modification (e.g., change and/or delta) between the signal transmitted by the computing device 102 and the signal received by the first data beacon. In certain embodiments, the modification may refer to a distance or difference in location the digital signal traveled through the communication network 114 and/or the communication circuitry 112. In certain embodiments, the illustrative program engine 104 may utilize the machine learning module 120 to calculate the distance, the location, and/or a propagation delay associated with the digital signal of the computing device 102 and the first data beacon of the plurality of data beacons. In some embodiments, the beacon locator module 118 may determine the modification between the signal transmitted by the computing device 102 and the signal received by the first data beacon of the plurality of data beacons.

In step 306, the illustrative program engine 104 may determine a geo-location of the computing device 102. In some embodiments, the illustrative program engine 104 may determine the geo-location of the computing device 102 based on the modification between the digital signals. In certain embodiments, the illustrative program engine 104 may determine the geo-location of the computing device 102 based on the calculated location of the machine learning module 120. In certain embodiments, the illustrative program engine 104 may apply a time domain reflectometry simulation to estimate a distance traveled associated with the digital signal. The time domain reflectometry simulation may refer to a measure of velocity of propagation at a high-frequency signal down waveguides via a medium, where the medium may refer to wires, waves, and/or networks. In certain embodiments, the illustrative program engine 104 may apply a time domain transmissometry simulation to estimate the distance traveled associated with the digital signal. The time domain transmissometry simulation may refer to a measure of time taken for an electromagnetic wave to propagate along a given length of a transmission line via the medium. In some embodiments, the illustrative program engine 104 may utilize the geo-location of the computing device 102 to determine if the computing device 102 is located within the permissible triangulated area in real-time. In some embodiments, the beacon locator module 118 may determine the geo-location of the computing device 102 based on the modification between the digital signals.

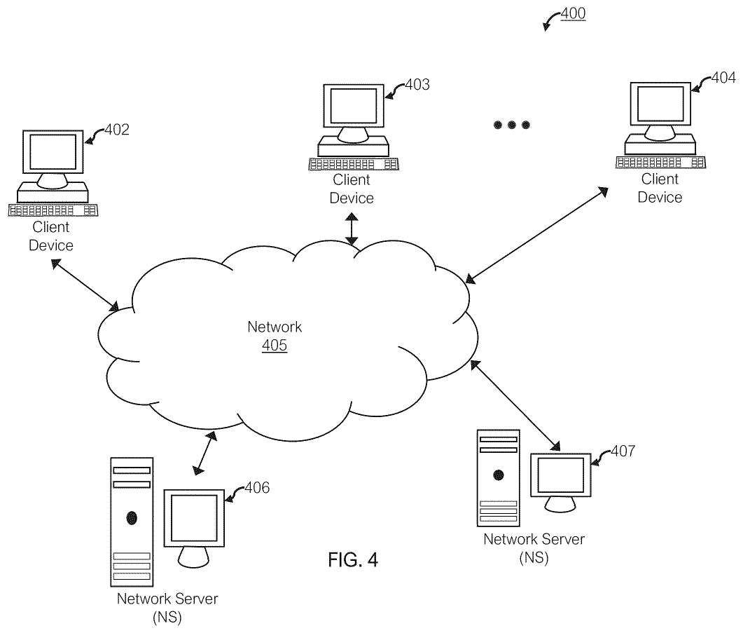

FIG. 4 depicts a block diagram of an exemplary computer-based system/platform 400 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the exemplary inventive computing devices and/or the exemplary inventive computing components of the exemplary computer-based system/platform 400 may be configured to automatically authenticate an action associated with the computing device 102 based on a data beacon generating a primed signal and dynamically update a storage module 124 associated with the computing device 102 with metadata based on a transmission of data in response to the execution of the action, as detailed herein. In some embodiments, the exemplary computer-based system/platform 400 may be based on a scalable computer and/or network architecture that incorporates various strategies for assessing the data, caching, searching, and/or database connection pooling. An example of the scalable architecture is an architecture that is capable of operating multiple servers. In some embodiments, the exemplary inventive computing devices and/or the exemplary inventive computing components of the exemplary computer-based system/platform 400 may be configured to manage the exemplary beacon locator module 118 of the present disclosure, utilizing at least one machine-learning model described herein.

In some embodiments, referring to FIG. 4, members 402-404 (e.g., clients) of the exemplary computer-based system/platform 400 may include virtually any computing device capable of automatically authenticating an action associated with the computing device 102 based on a data beacon of a plurality of data beacons generating a primed signal via a network (e.g., cloud network), such as network 405, to and from another computing device, such as servers 406 and 407, each other, and the like. In some embodiments, the member devices 402-404 may be personal computers, multiprocessor systems, microprocessor-based or programmable consumer electronics, network PCs, and the like. In some embodiments, one or more member devices within member devices 402-404 may include computing devices that connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 402-404 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 402-404 may launch one or more applications, such as Internet browsers, mobile applications, voice calls, video games, videoconferencing, and email, among others. In some embodiments, one or more member devices within member devices 402-404 may be configured to receive and to send web pages, and the like. In some embodiments, an exemplary beacon locator module 118 of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 402-404 may be specifically programmed by either Java,.Net, QT, C, C++ and/or other suitable programming language. In some embodiments, one or more member devices within member devices 402-404 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 405 may provide network access, data transport and/or other services to any computing device coupled to it. In some embodiments, the exemplary network 405 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 405 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 405 may include and implement, as an alternative or in conjunction with one or more of the above, a WiMAX architecture defined by the WiMAX forum. In some embodiments and, optionally, in combination of any embodiment described above or below, the exemplary network 405 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 405 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 405 may also include mass storage, such as network attached storage (NAS), a storage area network (SAN), a content delivery network (CDN) or other forms of computer or machine-readable media.

In some embodiments, the exemplary server 406 or the exemplary server 407 may be a web server (or a series of servers) running a network operating system, examples of which may include but are not limited to Microsoft Windows Server, Novell NetWare, or Linux. In some embodiments, the exemplary server 406 or the exemplary server 407 may be used for and/or provide cloud and/or network computing. Although not shown in FIG. 4, in some embodiments, the exemplary server 406 or the exemplary server 407 may have connections to external systems like email, SMS messaging, text messaging, ad content providers, etc. Any of the features of the exemplary server 406 may be also implemented in the exemplary server 407 and vice versa.

In some embodiments, one or more of the exemplary servers 406 and 407 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 401-404.

In some embodiments and, optionally, in combination of any embodiment described above or below, for example, one or more exemplary computing member devices 402-404, the exemplary server 406, and/or the exemplary server 407 may include a specifically programmed software module that may be configured to automatically authenticate an action associated with the computing device 102 based on a data beacon generating a primed signal; dynamically update a storage module 124 associated with the computing device 102 with metadata based on a transmission of data in response to the execution of the action; and predict a plurality of trends associated with a plurality of dynamic updates to the storage module 124 over the predetermined period of time by the exemplary beacon locator module 118.

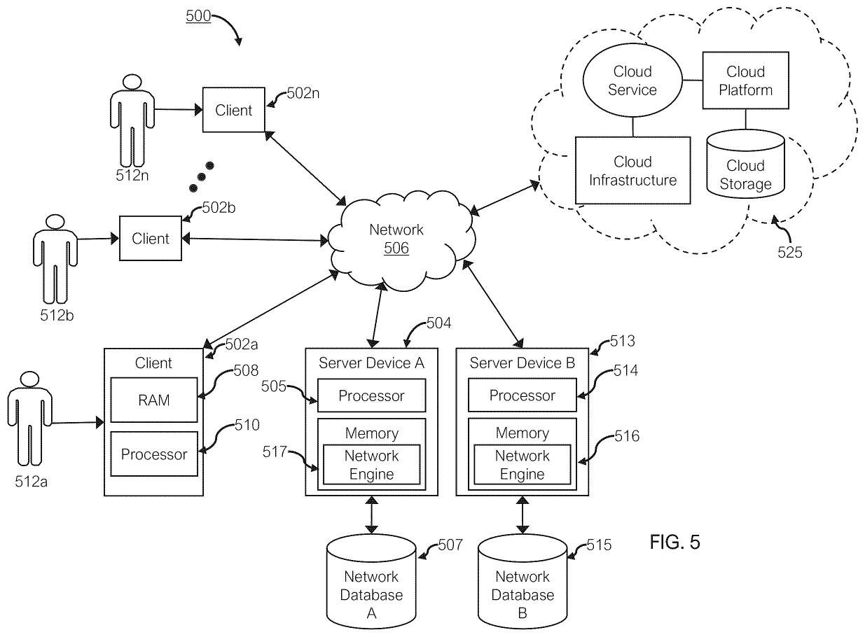

FIG. 5 depicts a block diagram of another exemplary computer-based system/platform 500 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices 502a, 502b thru 502n shown each at least includes a computer-readable medium, such as a random-access memory (RAM) 508 coupled to a processor 510 or FLASH memory. In some embodiments, the processor 510 may execute computer-executable program instructions stored in memory 508. In some embodiments, the processor 510 may include a microprocessor, an ASIC, and/or a state machine. In some embodiments, the processor 510 may include, or may be in communication with, media, for example computer-readable media, which stores instructions that, when executed by the processor 510, may cause the processor 510 to perform one or more steps described herein. In some embodiments, examples of computer-readable media may include, but are not limited to, an electronic, optical, magnetic, or other storage or transmission device capable of providing a processor, such as the processor 510 of client 502a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 502a through 502n may also comprise a number of external or internal devices such as a mouse, a CD-ROM, DVD, a physical or virtual keyboard, a display, a speaker, or other input or output devices. In some embodiments, examples of member computing devices 502a through 502n (e.g., clients) may be any type of processor-based platforms that are connected to a network 506 such as, without limitation, personal computers, digital assistants, personal digital assistants, smart phones, pagers, digital tablets, laptop computers, Internet appliances, and other processor-based devices. In some embodiments, member computing devices 502a through 502n may be specifically programmed with one or more application programs in accordance with one or more principles/methodologies detailed herein. In some embodiments, member computing devices 502a through 502n may operate on any operating system capable of supporting a browser or browser-enabled application, such as Microsoft™, Windows™, and/or Linux. In some embodiments, member computing devices 502a through 502n shown may include, for example, personal computers executing a browser application program such as Microsoft Corporation's Internet Explorer™, Apple Computer, Inc.'s Safari™, Mozilla

Firefox, and/or Opera. In some embodiments, through the member computing client devices 502a through 502n, users, 512a through 512n, may communicate over the exemplary network 506 with each other and/or with other systems and/or devices coupled to the network 506. As shown in FIG. 5, exemplary server devices 504 and 513 may be also coupled to the network 506. Exemplary server device 504 may include a processor 505 coupled to a memory that stores a network engine 517. Exemplary server device 513 may include a processor 514 coupled to a memory 516 that stores a network engine. In some embodiments, one or more member computing devices 502a through 502n may be mobile clients. As shown in FIG. 5, the network 506 may be coupled to a cloud computing/architecture(s) 525. The cloud computing/architecture(s) 525 may include a cloud service coupled to a cloud infrastructure and a cloud platform, where the cloud platform may be coupled to a cloud storage.

In some embodiments, at least one database of exemplary databases 507 and 515 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

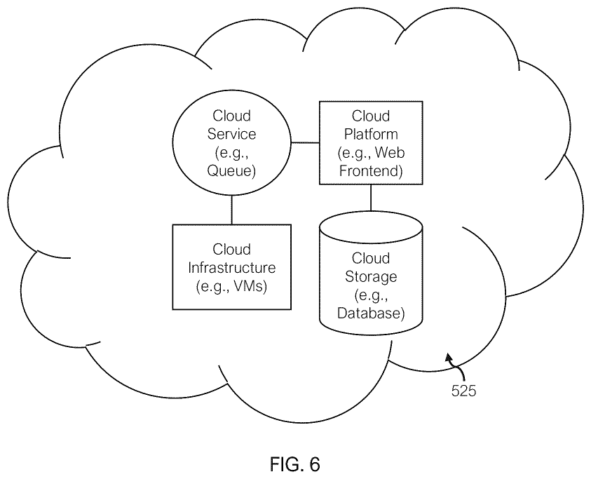

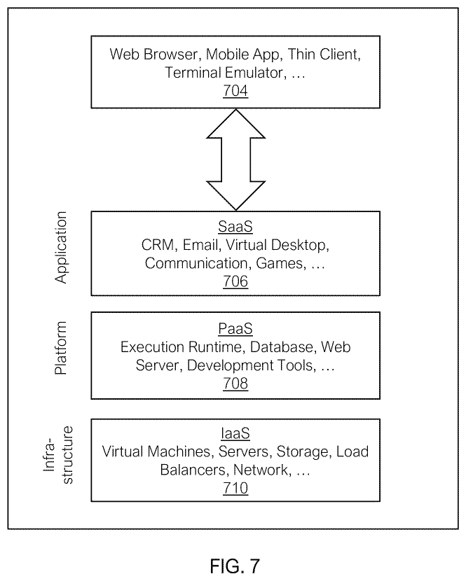

FIG. 6 and FIG. 7 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate. FIG. 6 illustrates an expanded view of the cloud computing/architecture(s) 525 found in FIG. 5. FIG. 7. illustrates the exemplary inventive computer-based components of the present disclosure may be specifically configured to operate in the cloud computing/architecture 525 as a source database 704, where the source database 704 may be a web browser. a mobile application, a thin client, and a terminal emulator. In FIG. 7, the exemplary inventive computer-based systems/platforms, the exemplary inventive computer-based devices, and/or the exemplary inventive computer-based components of the present disclosure may be specifically configured to operate in an cloud computing/architecture such as, but not limiting to: infrastructure a service (IaaS) 710, platform as a service (PaaS) 708, and/or software as a service (SaaS) 706.

In some embodiments and, optionally, in combination with any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination with any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination with any embodiment described above or below, the exemplary aggregation function may be a mathematical function that combines (e.g., sum, product, etc.) input signals to the node. In some embodiments and, optionally, in combination with any embodiment described above or below, an output of the exemplary aggregation function may be used as input to the exemplary activation function. In some embodiments and, optionally, in combination with any embodiment described above or below, the bias may be a constant value or function that may be used by the aggregation function and/or the activation function to make the node more or less likely to be activated.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; knowledge corpus; stored audio recordings; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. In some embodiments, the server may store transactions and dynamically trained machine learning models. Cloud servers are examples.

In some embodiments, as detailed herein, one or more of exemplary inventive computer-based systems/platforms, exemplary inventive computer-based devices, and/or exemplary inventive computer-based components of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a social media post, a map, an entire application (e.g., a calculator), etc. In some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) FreeBSD™, NetBSD™, OpenBSD™; (2) Linux™; (3) Microsoft Windows™; (4) OS X (MacOS)™; (5) MacOS 11™; (6) Solaris™; (7) Android™ (8) iOS™; (9) Embedded Linux™; (10) Tizen™; (11) WebOS™; (12) IBM i™; (13) IBM AIX™; (14) Binary Runtime Environment for Wireless (BREW)™; (15) Cocoa (API)™; (16) Cocoa Touch™; (17) Java Platforms™; (18) JavaFX™; (19) JavaFX Mobile;™ (20) Microsoft DirectX™; (21).NET Framework™; (22) Silverlight™; (23) Open Web Platform™; (24) Oracle Database™; (25) Qt™; (26) Eclipse Rich Client Platform™; (27) SAP NetWeaver™; (28) Smartface™; and/or (29) Windows Runtime™.

In some embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device. In at least one embodiment, the exemplary ASR system of the present disclosure, utilizing at least one machine-learning model described herein, may be referred to as exemplary software.

In some embodiments, exemplary inventive computer-based systems/platforms, exemplary inventive computer-based devices, and/or exemplary inventive computer-based components of the present disclosure may be configured to handle numerous concurrent tests for software agents that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like.

In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

In some embodiments, exemplary inventive computer-based systems/platforms, exemplary inventive computer-based devices, and/or exemplary inventive computer-based components of the present disclosure may be configured to be utilized in various applications which may include, but not limited to, the exemplary ASR system of the present disclosure, utilizing at least one machine-learning model described herein, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

The aforementioned examples are, of course, illustrative and not restrictive.

At least some aspects of the present disclosure will now be described with reference to the following numbered clauses.

Clause 1. A computer-implemented method may include: receiving, by a processor, a permission from a user of a plurality of users to monitor a location associated with a device, utilizing, by the processor, a plurality of geo-fencing sensors to triangulate the location associated with the device; utilizing, by the processor, a machine learning algorithm to automatically authenticate an action associated with the device based on a data beacon generating a primed signal; transmitting, by the processor, a plurality of data from the device to an external data source associated with the action within a predetermined period of time based on the location of the device and the primed signal; automatically authenticating an execution of the action associated with the device in response to an attempt of an action within a permissible geo-location area based on the location associated with the device; and dynamically updating, by the processor, a storage module associated with the device with metadata based on a transmission of the plurality of data associated with the action.

Clause 2. The method according to clause 1, where the action may include a transfer of data from an account associated with the user to a server computing device associated with the external data source.

Clause 3. The method according to clause 1 or 2, where the device includes a smart credit card capable of performing data transfers between two data sources.

Clause 4. The method according to clause 1, 2 or 3, where the permission from the user allows activity associated with the device to occur in an absence of the user within a permissible area.

Clause 5. The method according to clause 1, 2, 3 or 4, where the permissible area includes a triangulated location associated with the plurality of data beacons communicating with the device.

Clause 6. The method according to clause 1, 2, 3, 4 or 5, where a utilization of the plurality of geo-fencing sensors includes a location with an accuracy within a range of certainty ranging from a minimum of less than one foot and a maximum of ten feet from the data beacon of a plurality of data beacons

Clause 7. The method according to clause 1, 2, 3, 4, 5 or 6, further includes utilizing the plurality of geo-fencing sensors to continually locate the location of the device in real-time for an extended period of time in response to the device remaining within a triangulated area.

Clause 8. The method according to clause 1, 2, 3, 4, 5, 6 or 7, where the primed signal includes a digital signal associated with a first data beacon of a plurality of data beacons within a triangulated area, and the primed signal occurs in response to an execution of a permissible action.

Clause 9. The method according to clause 1, 2, 3, 4, 5, 6, 7 or 8, where an authentication of the action includes: verifying an identity of the user of the plurality of users associated with the device; and verifying the permission of a verified user to allow the action to occur in an absence of a presence of the verified user.

Clause 10. The method according to clause 1, 2, 3, 4, 5, 6, 7, 8 or 9, further including predicting a plurality of trends associated with a plurality of dynamic updates to the storage module of the device over the predetermined period of time.

Clause 11. The method according to clause 1, 2, 3, 4, 5, 6, 7, 8, 9 or 10, where the plurality of trends includes a plurality of identifiable features associated with the action.

Clause 12. The method according to clause 1, 2, 3, 4, 5, 6, 7, 8, 9, 10 or 11, further including automatically terminating an execution of the action associated with the device in response to an attempt of an action outside of a permissible geo-location area or outside of a permissible period of time.

Clause 13. A computer-implemented method may include: receiving, by a processor, a permission from a user of a plurality of users to monitor a location associated with a device, utilizing, by the processor, a plurality of geo-fencing sensors to triangulate the location associated with the device; utilizing, by the processor, a machine learning algorithm to automatically authenticate an action associated with the device based on a data beacon generating a primed signal; transmitting, by the processor, a plurality of data from the device to an external data source associated with the action within a predetermined period of time based on the location of the device and the primed signal; dynamically updating, by the processor, a storage module associated with the device with metadata based on a transmission of the plurality of data associated with the action; and predicting a plurality of trends associated with a plurality of dynamic updates to the storage module of the device over the predetermined period of time.

Clause 14. The method according to clause 13, where the action includes a transfer of data from an account associated with the user to a server computing device associated with the external data source.

Clause 15. The method according to clause 13 or 14, where the device includes a smart credit card capable of performing data transfers between two data sources.

Clause 16. The method according to clause 13, 14 or 15, where the permission from the user allows activity associated with the device to occur in an absence of the user within a permissible area.

Clause 17. The method according to clause 13, 14, 15 or 16, where a utilization of the plurality of geo-fencing sensors includes a location with an accuracy within a range of certainty ranging from a minimum of less than one foot and a maximum of ten feet from the data beacon of a plurality of data beacons.

Clause 18. The method according to clause 13, 14, 15, 16 or 17, where the primed signal includes a digital signal associated with a first data beacon of a plurality of data beacons within a triangulated area, and the primed signal occurs in response to an execution of a permissible action.

Clause 19. The method according to clause 13, 14, 15, 16, 17 or 18, where an authentication of the action includes: verifying an identity of the user of the plurality of users associated with the device; and verifying the permission of a verified user to allow the action to occur in an absence of a presence of the verified user.

A system may include: a non-transient computer memory, storing software instructions; at least one processor of a first computing device associated with a user; where, when the processor executes the software instructions, the first computing device is programmed to: receive a permission from a user of a plurality of users to monitor a location associated with a device, utilize a plurality of geo-fencing sensors to triangulate the location associated with the device; utilize a machine learning algorithm to automatically authenticate an action associated with the device based on a data beacon generating a primed signal; transmit a plurality of data from the device to an external data source associated with the action within a predetermined period of time based on the location of the device and the primed signal; automatically authenticate an execution of the action associated with the device in response to an attempt of an action within a permissible geo-location area based on the location associated with the device; and dynamically update a storage module associated with the device with metadata based on a transmission of the plurality of data associated with the action.

While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

1. A computer-implemented method comprising:
receiving, by a processor, a permission from a user of a plurality of users to monitor a location of a device;
utilizing, by the processor and in response to the receiving the permission from the user, a plurality of geo-fencing sensors to triangulate the location of the device;
utilizing, by the processor, a machine learning algorithm to automatically authenticate an execution of an action associated with the device based on a data beacon generating a primed signal when the location of the device is within a permissible area;
wherein the primed signal is a signal that is generated in response to at least one permissible action;
transmitting, by the processor, a plurality of data from the device to an external data source associated with the action within a predetermined period of time based on the location of the device and the primed signal; and
dynamically updating, by the processor, a storage module associated with the device with metadata based on a transmission of the plurality of data associated with the action.

2. The method of claim 1, wherein the action comprises a transfer of data from an account associated with the user to a server computing device associated with the external data source.

3. The method of claim 1, wherein the device comprises a smart credit card capable of performing data transfers between two data sources.

4. The method of claim 1, wherein the permission from the user allows activity associated with the device to occur in an absence of the user within a permissible area.

5. The method of claim 4, wherein the permissible area comprises a triangulated location associated with plurality of data beacons communicating with the device.

6. The method of claim 1, wherein a utilization of the plurality of geo-fencing sensors comprises a location with an accuracy within a range of certainty ranging from a minimum of less than one foot and a maximum of ten feet from the data beacon of a plurality of data beacons.

7. The method of claim 1, further comprising utilizing the plurality of geo-fencing sensors to continually locate the location of the device in real-time for an extended period of time in response to the device remaining within a triangulated area.

8. The method of claim 1, wherein the primed signal comprises a digital signal associated with a first data beacon of a plurality of data beacons within a triangulated area, and the primed signal occurs in response to an execution of a permissible action.

9. The method of claim 1, wherein an authentication of the action comprises:
verifying an identity of the user of the plurality of users associated with the device; and
verifying the permission of a verified user to allow the action to occur in an absence of a presence of the verified user.

10. The method of claim 1, further comprising predicting a plurality of trends associated with a plurality of dynamic updates to the storage module of the device over the predetermined period of time.

11. The method of claim 10, wherein the plurality of trends comprise a plurality of identifiable features associated with the action.

12. The method of claim 1, further comprising automatically terminating an execution of the action associated with the device in response to an attempt of an action outside of a permissible geo-location area or outside of a permissible period of time.

13. A computer-implemented method comprising:
receiving, by a processor, a permission from a user of a plurality of users to monitor a location of a device;
utilizing, by the processor, a plurality of geo-fencing sensors to triangulate the location of the device;
utilizing, by the processor, a machine learning algorithm to automatically authenticate an execution of an action associated with the device based on a data beacon generating a primed signal when the location of the device is within a permissible area;
wherein the primed signal is a signal that is generated in response to at least one permissible action;
transmitting, by the processor, a plurality of data from the device to an external data source associated with the action within a predetermined period of time based on the location of the device and the primed signal;
dynamically updating, by the processor, a storage module associated with the device with metadata based on a transmission of the plurality of data associated with the action; and
predicting a plurality of trends associated with a plurality of dynamic updates to the storage module of the device over the predetermined period of time.

14. The method of claim 13, wherein the action comprises a transfer of data from an account associated with the user to a server computing device associated with the external data source.

15. The method of claim 13, wherein the device comprises a smart credit card capable of performing data transfers between two data sources.

16. The method of claim 13, wherein the permission from the user allows activity associated with the device to occur in an absence of the user within a permissible area.

17. The method of claim 13, wherein a utilization of the plurality of geo-fencing sensors comprises a location with an accuracy within a range of certainty ranging from a minimum of less than one foot and a maximum of ten feet from the data beacon of a plurality of data beacons.

18. The method of claim 13, wherein the primed signal comprises a digital signal associated with a first data beacon of a plurality of data beacons within a triangulated area, and the primed signal occurs in response to an execution of a permissible action.

19. The method of claim 13, wherein an authentication of the action comprises:
verifying an identity of the user of the plurality of users associated with the device; and
verifying the permission of a verified user to allow the action to occur in an absence of a presence of the verified user.

20. A system comprises:
a non-transient computer memory, storing software instructions;
at least one processor of a first computing device associated with a user;
wherein, when the processor executes the software instructions, the first computing device is programmed to:
receive a permission from a user of a plurality of users to monitor a location of a device;
utilize a plurality of geo-fencing sensors to triangulate the location of the device;
utilize a machine learning algorithm to automatically authenticate an execution of an action associated with the device based on a data beacon generating a primed signal when the location of the device is within a permissible area;
wherein the primed signal is a signal that is generated in response to at least one permissible action;
transmit a plurality of data from the device to an external data source associated with the action within a predetermined period of time based on the location of the device and the primed signal; and
dynamically update a storage module associated with the device with metadata based on a transmission of the plurality of data associated with the action.
